(19) United States
(12) Patent Application Publication
(10) Pub. No.: US 2012/0020054 A1
(43) Pub. Date: Jan. 26, 2012

(54) BACKLIGHT MODULE

(75) Inventors: HSU SHAN, Kaohsiung City (TW); Shin-chang Chen, Jincheng Township (TW)

(73) Assignee: CHUNGHWA PICTURE TUBES, LTD., Bade City (TW)

(21) Appl. No.: 12/890,643

(22) Filed: Sep. 25, 2010

(30) Foreign Application Priority Data
Jul. 22, 2010 (TW) 099213978

(51) Int. Cl. G09F 13/04

(52) U.S. Cl. 362/97.1

(57) ABSTRACT

A backlight module is disclosed. A flexible printed circuit (FPC) is prevented detaching from a connector in the backlight module. The backlight module includes a mold frame, an FPC, a stiffener, a connector and a fastener. The stiffener has a first part and a second part, that the first part is attached on a first end of the FPC. The first end of the FPC together with the stiffener is electrically coupled to the connector. The fastener which is disposed on the mold frame has a slot, and the second part of the stiffener is inserted into the said slot of the fastener so that the FPC is firmly inserted into the connector by the stiffener.

### TECHNICAL FIELD OF THE INVENTION

The present invention relates to a backlight module, and especially to a backlight module in which a flexible printed circuit (FPC) detaching from a connector is prevented.

### BACKGROUND OF THE INVENTION

A conventional liquid crystal display (LCD) includes an LCD panel and a backlight module. The backlight module is used to provide illumination because the LCD panel cannot actively emit light. A cold cathode fluorescent lamp (CCFL) or a light emitting diode (LED) is commonly used as a light source for the backlight module. Since the LED has more advantages such as low power consumption, long lifespan, no mercury additives and many more, the LED is gradually replacing CCFL to be a mainstream backlight source.

Referring to FIG. 1, FIG. 1 is a partial structural diagram schematically showing a backlight module in the prior art. A light bar (not shown) and a printed circuit board (PCB) 12 are generally designed to be located in the opposite sides of the LCD panel as desired. Thus, a flexible printed circuit (FPC) 20, which is electrically coupled to the light bar, has to get across the backlight module 10 to be linked to the connector 30 located on the printed circuit board 12. At present, a groove 42 of a mold frame 40 is utilized to fix the FPC 20. However, because the FPC 20 has to be extended over a long distance, the FPC 20 may be detached from the connector 30 whereby an insufficient clamping force or being badly fixed during shipping or reliability verification, hence resulting in problems of a backlight dark block or the backlight unlighted and so on.

At present, a solution is proposed that an adhesive tape 50 (indicated by dashed lines) is attached on a loose part for strengthening the connection between the FPC 20 and the connector 30 while the FPC 20 is assembled into the connector 30. However, such a solution requires additional process for attaching the adhesive tape and cost of the adhesive tape. Furthermore, the speed of assembling is reduced.

### SUMMARY OF THE INVENTION

To overcome the above-mentioned drawbacks, an objective of the present invention is to provide a backlight module, in which an FPC is able to firmly insert into a connector.

Another objective of the present invention is to provide a backlight module which will reduce the cost and time of attaching the adhesive tapes.

To achieve the foregoing objectives, according to an aspect of the present invention, a backlight module which is applicable to prevent a flexible printed circuit (FPC) detaching from a connector comprises a mold frame, an FPC, a stiffener, a connector, and a fastener. The FPC is disposed on the mold frame. The stiffener has a first part and a second part, whereby the first part is attached thereon a first end of the FPC. The first end of the FPC together with the stiffener is electrically coupled to the connector. The fastener which is disposed on the mold frame has a slot, and the second part of the stiffener is inserted into the slot of the fastener, thereby enabling the FPC to be firmly inserted into the connector by the stiffener.

More specifically, the second part of the stiffener abuts against a bottom of the slot for generating a thrust force to enable the FPC to be inserted into the connector by pushing the first part of the stiffener.

In one preferred embodiment, the stiffener is made of flexible plastic material. In addition, the fastener, which is disposed on the mold frame, is located above the FPC, and the fastener is formed an integral part with the mold frame. The slot of the fastener has a first opening corresponding to the second part of the stiffener. Furthermore, the slot has a second opening corresponding to a lateral side of the stiffener, and thereby the stiffener is able to be inserted into the slot via the second opening.

In accordance with the preferred embodiment of the present invention, the stiffener is inserted into the slot of the fastener, which is integrally formed one piece with the mold frame. Accordingly, the FPC can be firmly inserted into the connector by the thrust force through the stiffener abutting against a bottom of the slot. Therefore, the drawbacks in the prior art with respect to the cost and time of attaching the adhesive tapes are solved.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a partial structural diagram schematically showing a backlight module in the prior art.

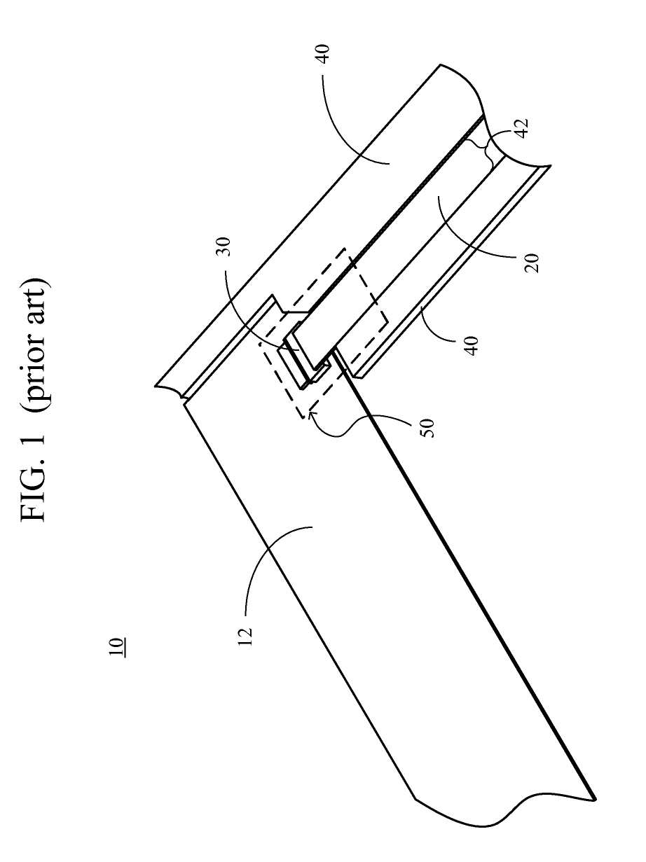

FIG. 2 is a perspective view schematically illustrating a partial backlight module in one preferred embodiment of the present invention.

FIG. 3 is a perspective view schematically illustrating a fastener in one preferred embodiment of the present invention.

FIG. 4 is a cross-sectional view schematically illustrating an FPC being inserted into a connector in one preferred embodiment of the present invention.

### DETAILED DESCRIPTION OF THE INVENTION

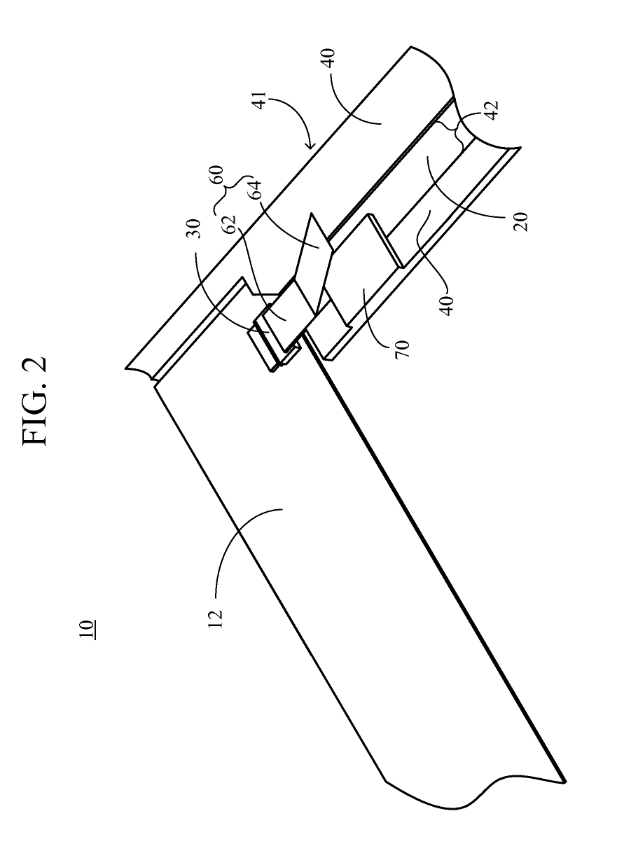

The present invention will now be described in detail with reference to a few preferred embodiments thereof as illustrated in the accompanying drawings. In different drawings, the same reference numbers will be used throughout the drawings to refer to the same or like parts. Referring to FIG. 2, FIG. 2 is a perspective view schematically illustrating a partial backlight module in one preferred embodiment of the present invention. A backlight module according to one preferred embodiment of the present invention is generally designated as a backlight module 10. The backlight module 10 includes a mold frame 40, a Flexible Printed Circuit (FPC) 20, a stiffener 60, a connector 30, and a fastener 70. The backlight module 10 according to the preferred embodiment is applicable to prevent the FPC 20 detaching from the connector 30.

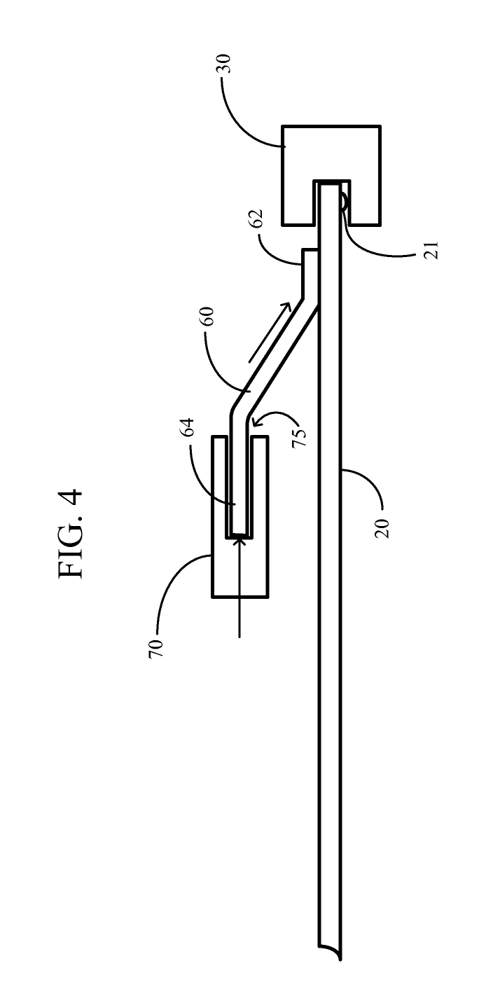

A side 41 of the mold frame 40, according to the preferred embodiment, has a groove 42 for holding the FPC 20. Furthermore, the side 41 can be any side of the mold frame 40, and the groove 42 is disposed in the right side of the mold frame 40 in the preferred embodiment. The FPC 20 is composed of copper foil, an insulating substrate and a binder. A thickness of the FPC 20 is about 0.1 mm, and the connecting golden finger which are exposed on both ends of the FPC 20 for respectively electrically coupling to the connector 30 and a light-emitting diode (LED) light bar (not shown). In the preferred embodiment, the connecting golden finger 21 (i.e., contact points as shown in FIG. 4) of the FPC 20 are exposed on a bottom of a first end of the FPC 20, and the insulating substrate is located above the connecting golden finger 21. The insulating substrate is made of Polyimide (PI), Polyethylene terephthalate (PET), or other plastic material. The FPC 20 is disposed inside the groove 42 of the mold frame 40, and a second end of the FPC 20 is electrically coupled to an LED light bar (not shown), which is utilized to provide the lighting signals or power to the LED light bar.

A shape of the stiffener 60 which is similar to a folded plate has a first part 62 and a second part 64. The first part 62 is attached to the first end of the FPC 20 which is electrically coupled to the connector 30, and the second part 64 tilts as shown in FIG. 2. In the preferred embodiment, the stiffener 60, which is made of flexible plastic material such as polyimide (PI), is attached to the insulation substrate of the FPC 20. In the prior art, the second part 64 of the stiffener 60 is served as a handheld portion when the FPC 20 is connected to the connector 30.

The connector 30 according to the preferred embodiment is disposed on the printed circuit board (PCB) 12. The first end of the FPC 20, which is attached to the stiffener 60, is electrically coupled to the connector 30, and the first end of the FPC 20 is utilized to receive a signal provided from a circuit (not shown) of the printed circuit board (PCB) 12 and to transmit the signal to the LED light bar.

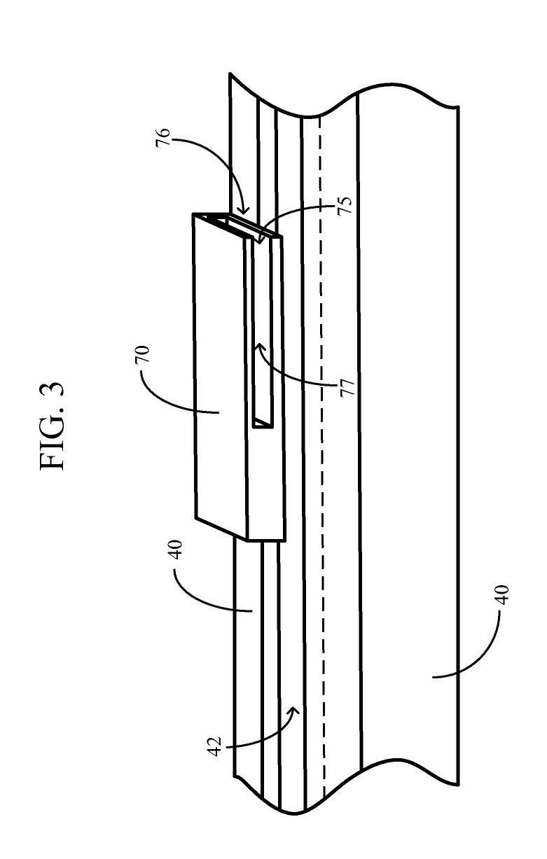

Referring to FIG. 3, FIG. 3 is a perspective view schematically illustrating the fastener in the preferred embodiment of the present invention. In order to explain clearly, the drawing only shows the fastener 70 and the mold frame 40 and does not show the FPC 20. The fastener 70 herein is disposed on the mold frame 40. More specifically, the fastener 70 is located above the FPC 20. The fastener 70 is utilized to fix the FPC 20 disposed inside the groove 42, thereby omitting the attachment of the adhesive tape. It is worth notice that the fastener 70 and the mold frame 40 are integrally formed as one piece, whereas the fastener 70 and the mold frame 40 can also be formed as respective components. In addition, the fastener 70 has a slot 75, wherein the second part64 of the stiffener 60 is inserted into the slot 75. Therefore, the FPC 20 is firmly inserted into the connector 30 by the stiffener 60.

The slot 75 according to the preferred embodiment has a first opening 76 which the first opening 76 corresponds to the second part64 of the stiffener 60, and thereby the second part 64 of the stiffener 60 can be inserted into the slot 75 from the first opening 76. In the preferred embodiment, the slot 75 of the fastener 70 further has a second opening 77 corresponding to a lateral side of the stiffener 60, so that an operator can sidewise insert the stiffener 60 into the slot 75 via the second opening 77. It should be noted that the opening first 76 and the second opening 77 are interconnected. Accordingly, the stiffener 60 does not have to be completely held inside the slot 75; that is, the second part 64 of the stiffener 60 can extend out of the slot 75.

FIG. 4 is a cross-sectional view schematically illustrating the FPC being inserted into the connector in the preferred embodiment of the present invention. In order to explain clearly, the drawing does not show the mold frame 40. Referring to FIG. 4, the second part 64 of the stiffener 60 abuts against a bottom of the slot 75, and thereby the slot 75 generates a thrust force toward the stiffener 60 (the direction of the thrust force as shown in FIG. 4, i.e., reaction force). The FPC 20 is pushed forward by the first part 62 of the stiffener 60 whereby the FPC 20 is firmly inserted into the connector 30 by the thrust force.

In addition, the backlight module 10 of the preferred embodiment further includes a reflector, a light guide plate, brightness enhancement film (BEF) and other optical films (not shown) which are well-known to a person skilled in the art; moreover, the backlight module 10 further includes a backplane and other components without going into details here.

In summary, according to the backlight module of the preferred embodiment of the present invention, the stiffener 60 is inserted into the slot 75 of the fastener 70, which is integrally formed with the mold frame 40. Accordingly, the FPC 20 can be firmly inserted into the connector 30 by the thrust force formed from the stiffener 60 abutting against on the bottom of the slot 75. Therefore, the drawbacks with respect to the cost and time of attaching the adhesive tapes are solved in the prior art.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A backlight module, comprising:
a mold frame;
a flexible printed circuit (FPC) disposed on the mold frame;
a stiffener having a first part and a second part, the first part being attached on a first end of the FPC;
a connector being electrically coupled the FPC by inserting the first end of the FPC having the stiffener attached thereon into the connector; and
a fastener disposed on the mold frame, said fastener comprising a slot;
wherein the second part of the stiffener is inserted into the slot of the fastener.

2. The backlight module of claim 1, wherein the second part of the stiffener abuts against a bottom of the slot for generating a thrust force enabling the FPC to be pushed by the first part of the stiffener and inserted into the connector.

3. The backlight module of claim 1, wherein the stiffener is made of flexible plastic material.

4. The backlight module of claim 1, wherein the fastener is disposed on the mold frame and located above the FPC.

5. The backlight module of claim 1, wherein the fastener and the mold frame are integrally formed.

6. The backlight module of claim 1, wherein the slot of the fastener has a first opening corresponding to the second part of the stiffener.

7. The backlight module of claim 6, wherein the slot of the fastener further has a second opening corresponding to a lateral side of the stiffener.

8. The backlight module of claim 1, wherein the connector is disposed on a printed circuit board (PCB).

9. The backlight module of claim 1, wherein a second end of the FPC is electrically coupled to an LED light bar.
